(19) United States
(12) Patent Application Publication
(10) Pub. No.: US 2011/0305946 A1
(43) Pub. Date: Dec. 15, 2011

(54) SEALED BATTERY AND METHOD OF PRODUCING SEALED BATTERY

(76) Inventor: Kenshiro Moride, Aichi (JP)

(21) Appl. No.: 13/201,473

(22) PCT Filed: Mar. 4, 2009
(86) PCT No.: PCT/JP2009/054090

§ 371 Date: Aug. 15, 2011

(51) Int. Cl. H01M 2/02; H01M 10/04

(52) U.S. Cl. 429/185; 29/623.1

(57) ABSTRACT

Provided are a sealed battery provided with a safety valve part having a sufficiently large opening area when open, and a method of producing such a sealed battery. The sealed battery is provided with an electric power generating element and a battery case having a safety valve part at a valve forming surface. The safety valve part has a thin-walled portion breaking when the safety valve part becomes open. The thin-walled portion has first to n-th linear thin-walled portions. The first to n-th linear thin-walled portions include an intersecting thin-walled portion. The thin-walled portion is adapted such that the breaking pressure of the intersecting thin-walled portion is lower than the breaking pressure of portions other than the intersecting thin-walled portion.

### CROSS-REFERENCE TO RELATED APPLICATIONS

This is a national phase application based on the PCT International Patent Application No. PCT/JP2009/054090 filed on Mar. 4, 2009, the entire contents of which are incorporated herein by reference.

### TECHNICAL FIELD

The present invention relates to a sealed battery including a battery case provided with a safety valve part and a method of producing the sealed battery.

### BACKGROUND ART

In recent years, popularization of portable electronic devices such as a cellular phone, a notebook-sized PC, and a video camcorder, and vehicles such as a hybrid electric vehicle have increased demands for batteries for use as power sources for driving them.

There is a case such batteries are provided with a safety valve to release the internal pressure thereof when abnormally rises. For instance, Patent Document 1 discloses safety valves including second thin-walled portions (thin-walled portions) formed in a Z-shape, in a straight shape whose ends open in a Y shape respectively, and in an X-shape.

### RELATED ART DOCUMENTS

### Patent Documents

Patent Document 1: JP2006-216435A

### DISCLOSURE OF THE INVENTION

### Problems To Be Solved By the Invention

As a technique for forming the X-shaped thin-walled portion disclosed in Patent Document 1, there is a single-stage press process using a single press die, that is, a press operation using a press die formed with a press blade consisting of intersecting straight blades. However, in this press die, an intersecting portion of the press blade is difficult to produce.

To be concrete, as shown in an enlarged form in FIG. 1, a press blade PC of a press die PK is designed so that a first straight press blade portion P1 and a second straight press blade portion P2 each having a straight strip shape protruding upward respectively in FIG. 1. Those first and second press blade portions P1 and P2 intersect at an intersecting portion PX. Meanwhile, this press blade PC is formed by use of a tool such as a router (not shown). The intersecting portion PX of the press blade PC could not be easily machined to such a configuration as shown by a dashed dotted line in FIG. 1, i.e., four sharp corner forming portions AP which are generated by intersection of the first and second press blade portions P1 and P2. Actually, they are formed as round corners as shown in FIG. 1.

In the case where a safety valve part is made by use of the press die PK having the press blade PC, an X-shaped thin-walled portion is formed with an inverted relief structure with respect to the press blade PC (see FIG. 2). Accordingly, in an intersecting region JX formed by press in the intersecting portion PX, there are formed not only a first straight thin-walled portion JL1 and a second straight thin-walled portion JL2 but also wedged thin-walled portions JXZ each corresponding to a corner defined therebetween.

Moreover, regarding a sealed battery including a safety valve part formed with such a thin-walled portion, it has been found that it is uncertain which portion is first to start to cleave or split off in the intersecting region JX of the thin-walled portion when the safety valve part is to be opened. For this reason, for instance, it has been found that, if a diamond-shaped intersecting thin-walled portion JXS surrounded by dashed dotted lines in FIG. 2 is first to start to cleave, the cleaving advances from this intersecting portion JXS in four directions, then cleaving all of the four straight thin-walled portions JL11, JL12, JL21, and JL22 formed by the first and second thin-walled straight portions JL1 and JL2. When the thin-walled straight portions cleave in such a manner, the safety valve part could ensure a sufficient opening area by the cleaving.

On the other hand, when a wedged thin-walled portion JXZ starts to cleave earlier than other portions of the intersecting region JX of the thin-walled portion, any one (or more) of the four straight portions JL11, JL12, JL21, and JL22 may not cleave. In this case, a sufficient opening area of the safety valve part could not be ensured by the cleaving.

The present invention has been made to solve the above problems and has a purpose to provide a sealed battery including a safety valve part capable of ensuring a sufficient opening area when opened. Another purpose is to provide a method of producing such sealed battery.

### Means of Solving the Problems

One aspect of the invention provides a sealed battery comprising: a power generating element; and a battery case hermetically housing the power generating element, the battery case including a safety valve part in a valve forming surface, the safety valve part including: a plate-like part having a predetermined thickness in its own thickness direction; and a groove-shaped thin-walled portion located within the plate-like part and formed with a thinner thickness than the plate-like part in the thickness direction and configured to cleave at a time of opening the valve part, wherein the thin-walled portion includes n thin-walled portions (n is an integer more than 2) consisting of first to n-th linear thin-walled portions each linearly extending, the first to n-th linear thin-walled portions include an intersecting thin-walled portion in which all of the first to n-th thin-walled linear portions intersect each other, the first to n-th linear thin-walled portions are configured so that, on both sides of a linearly extending narrow portion including the intersecting thin-walled portion, linearly extending portions wider than the linearly extending narrow portion including the intersecting thin-walled portion and longer than a width of the linearly extending narrow portion including the intersecting thin-walled portion are located, and the thin-walled portion is configured to cleave at a lower cleavage pressure than a cleavage pressure of other portions than the intersecting thin-walled portion.

In the above sealed battery, the thin-walled portion is designed so that the cleavage pressure of the intersecting thin-walled portion is lower than that of other portions excepting the intersecting thin-walled portion in the thin-walled portion. Therefore, when the safety valve part is to be opened, it is possible to reliably start cleaving from the intersecting thin-walled portion and cause a first linear thin-walled portion to an n-th linear thin-walled portion each extending from the intersecting thin-walled portion in respective directions to cleave along them. Consequently, the opened safety valve part can ensure sufficient opening area.

Further, each of the first to n-th linear thin-walled portions is configured so that, on both sides of a linearly extending narrow portion including an intersecting thin-walled portion (hereinafter, also referred to as an intersection-near portion), a linearly extending portion wider than the intersection-near portion and longer than a width of the intersection-near portion is located. Thus, when the safety valve part is to be opened, stress is likely to concentrate on the intersecting thin-walled portion of the thin-walled portion. This reduces a valve opening pressure at the intersecting thin-walled portion. Therefore, the intersecting thin-walled portion can reliably be first to start to cleave. Furthermore, the other portions excepting the intersection-near portion in the first to n-th linear thin-walled portions have a wider groove width than respective intersection-near portions. The cleaving having been advanced from the intersecting thin-walled portion is allowed to further advance in the portion other excepting the intersection-near portion. Consequently, the safety valve part can reliably ensure a sufficient opening area.

For instance, the first linear thin-walled portion to the n-th linear thin-walled portion (n is an integer more than 2) may include a straight thin-walled portion and a curved thin-walled portion. Further, the first to n-th linear thin-walled portions may be all in linear shape, all in curved shape, or some in linear shape and others in curved shape.

In the above sealed battery, preferably, the first to n-th thin-walled linear portions are a first-direction thin-walled portion extending in a first direction and a second-direction thin-walled portion extending in a second direction different from the first direction, the thin-walled portion includes the first-direction thin-walled portion and the second-direction thin-walled portion,

the thin-walled portion is configured so that the first-direction thin-walled portion and the second-direction thin-walled portion intersect each other in an X shape in the intersecting thin-walled portion when the valve forming surface is seen in a plan view, and an intersecting angle α between the first-direction thin-walled portion and the second-direction thin-walled portion in the intersecting thin-walled portion is set in a range of 30°≦α≦50°.

In the sealed battery, as the configuration of the safety valve part, it is conceivable that, when the valve forming surface is seen in a plan view, the first-direction and the second-direction thin-walled portions intersect in an X shape at the intersecting thin-walled portion. The present inventors found as mentioned later that the safety valve part of such sealed battery is designed so that the intersecting angle α between the first-direction thin-walled portion and the second-direction thin-walled portion in the intersecting thin-walled portion is set in a relation of 30°≦α≦50°, the cleavage pressure of the intersecting thin-walled portion could be made lower than that of the other portions of the thin-walled portion excepting the intersecting thin-walled portion.

Based on such findings, the above sealed battery is configured such that the intersecting angle α between the first-direction thin-walled portion and the second-direction thin-walled portion is determined in a range of 30°≦α≦50°. Accordingly, when the safety valve part is to be opened, the thin-walled portion can be reliably started to cleave from the intersecting thin-walled portion and thus advance cleaving along the first-direction thin-walled portions and the second-direction thin-walled portions extending from the intersecting thin-walled portion in four directions, thereby achieving an X-shaped cleavage.

(Deleted)

(Deleted)

Further, in one of the aforementioned sealed batteries, preferably, the intersecting thin-walled portion is configured to include a thinner portion than its own other portion.

The inventors found as mentioned later that when a part of the intersecting thin-walled portion is made thinner than respective other portions, the cleavage pressure of the intersecting thin-walled portion could be made lower than that of the other portions of the thin-walled portion than the intersecting thin-walled portion.

Accordingly, the aforementioned sealed battery can start to cleave from the intersecting thin-walled portion earlier than other portions of the thin-walled portion when the safety valve part is to be opened.

Another aspect of the invention provides a method of producing a sealed battery comprising: a power generating element; and a battery case hermetically housing the power generating element, the battery case including a safety valve part in a valve forming surface, the safety valve part including: a plate-like part having a predetermined thickness in its own thickness direction; and a groove-shaped thin-walled portion formed with a thinner thickness than the plate-like part in the thickness direction and configured to cleave at a time of opening the valve part, the thin-walled portion including n thin-walled portions (n is an integer more than 2) consisting of first to n-th linear thin-walled portions each linearly extending, the first to n-th linear thin-walled portions including an intersecting thin-walled portion in which all of the first to n-th thin-walled linear portions intersect each other, and the thin-walled portion being configured to cleave at a lower cleavage pressure than a cleavage pressure of other portions than the intersecting thin-walled portion, wherein the method comprises a linear thin-walled portion forming step of forming the first to n-th thin-walled linear portions individually in the plate-like part.

In the aforementioned method of producing the sealed battery, the first to n-th linear thin-walled portions are individually produced by the above linear thin-walled portion forming step. Unlike the configuration shown in FIG. 2, the intersecting region JX can be formed with no wedged thin-walled portion JXZ. Thus, at an opening time of the safety valve part, it is possible to reliably start cleaving from the intersecting thin-walled portion and advance the cleaving along the first to n-th linear thin-walled portions respectively extending from the intersecting thin-walled portion. Accordingly, it is possible to produce the sealed battery with the safety valve part capable of ensuring a sufficient opening area when opened.

The linear thin-walled portion forming step may be achieved for example by press molding using dies in the number of n or larger pieces or by grooving work.

### BRIEF DESCRIPTION OF THE DRAWINGS

FIG. 1 is an explanatory view of a press die for forming a safety valve part;

FIG. 2 is an explanatory view of a safety valve part formed by use of the press die shown in FIG. 1;

FIG. 3 is a perspective view of a battery in Embodiment 1 and Modified examples 1, 2, 3, and 4;

FIG. 4 is a cross sectional view (taken along a line A-A in FIG. 3) of the battery in Embodiment 1 and Modified examples 1, 2, 3, and 4;

FIG. 5 is an enlarged plan view of a part of the battery (a part B in FIG. 3) in Embodiment 1;

FIG. 6 is an enlarged cross sectional view of a part of the battery (a part C in FIG. 4) in Embodiment 1 and Modified example 1;

FIG. 7 is an explanatory view of a safety valve part used in CAE analysis;

FIG. 8 is an explanatory view of the safety valve part used in the CAE analysis (a cross sectional view taken along a line D-D in FIG. 7);

FIG. 9 is an explanatory view of a method of producing the battery in Embodiment 1;

FIG. 10 is an explanatory view of the method of producing the battery in Embodiment 1;

FIG. 11 is an enlarged plan view of a part of the battery (the part B in FIG. 3) in Modified example 1;

FIG. 12 is an explanatory view of a method of producing a battery in Modified example 1;

FIG. 13 is an explanatory view of the method of producing the battery in Modified example 1;

FIG. 14 is an explanatory view of a first press process and a second press process in Modified example 1;

FIG. 15 is an enlarged plan view of a battery (the part B in FIG. 3) in Modified example 2;

FIG. 16 is a cross sectional view of a part of the battery (taken along a line E-E in FIG. 15) in Modified example 2;

FIG. 17 is an enlarged plan view of a part of a battery (the part B in FIG. 3) in Modified example 3; and

FIG. 18 is an enlarged plan view of a part of a battery (the part B in FIG. 3) in Modified example 4.

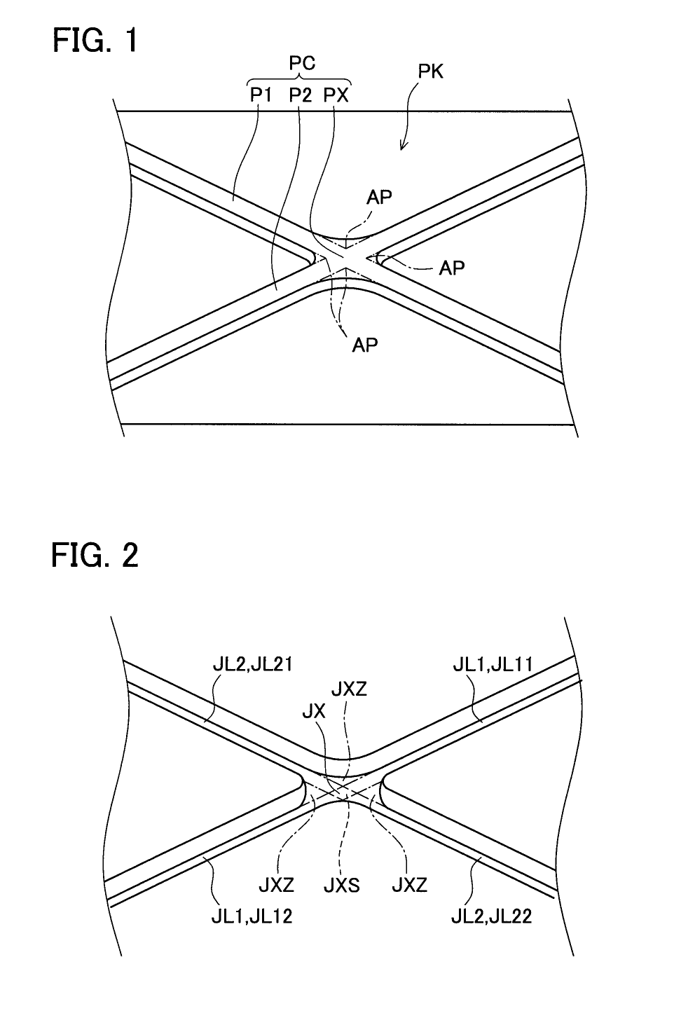

### DESCRIPTION OF THE REFERENCE SIGNS

1, 101, 201, 301, 401: Battery (Sealed battery)
10: Battery case
11F: Lid outer surface (Valve forming surface)
20, 120, 220, 320, 420: Safety valve part
21, 121, 221, 321, 421: Thin-walled portion
21T, 121T, 221T, 321T, 421T: Non-intersecting thin-walled portion (Other portion excepting intersecting thin-walled portion)
22, 122, 222: First-direction thin-walled portion (First linear thin-walled portion)
22G, 122G: First intersection-near portion (Linearly extending narrow portion including an intersecting thin-walled portion)
22H, 122H: First outside portion (Linearly extending portion wider than the linearly extending narrow portion including thin-walled portion and longer than a width of the linearly extending narrow portion including thin-walled portion)
23, 123, 223: Second-direction thin-walled portion (n-th linear thin-walled portion)
23G, 123G: Second intersection-near portion (Linearly extending narrow portion including an intersecting thin-walled portion)
23H, 123H: Second outside portion (Linearly extending portion wider than the linearly extending narrow portion including thin-walled portion and longer than a width of the linearly extending narrow portion including thin-walled portion)
26S, 126S, 226S, 326S, 426S: Intersecting thin-walled portion
28: Plate-like part
80: Power generating element
226SR: Intersecting thin-walled bottom portion (Part of intersecting thin-walled portion)
322: First-direction thin-walled portion (First linear thin-walled portion)
323: Second-direction thin-walled portion (n-th linear thin-walled portion)
324: Third-direction thin-walled portion (n-th linear thin-walled portion)
422: First curved thin-walled portion (First linear thin-walled portion)
423: Second curved thin-walled portion (n-th linear thin-walled portion)
α: Intersecting angle
DM: First direction
DN: Second direction
DT: Thickness direction
T2: Thickness (of thin-walled portion)
T3: Thickness (of intersecting thin-walled portion)
T3X: Thickness (of intersecting thin-walled bottom portion)
T4: Thickness (of wedged thin-walled portion)

### MODE FOR CARRYING OUT THE INVENTION

### Embodiment 1

A detailed description of Embodiment 1 of the present invention will now be given referring to the accompanying drawings.

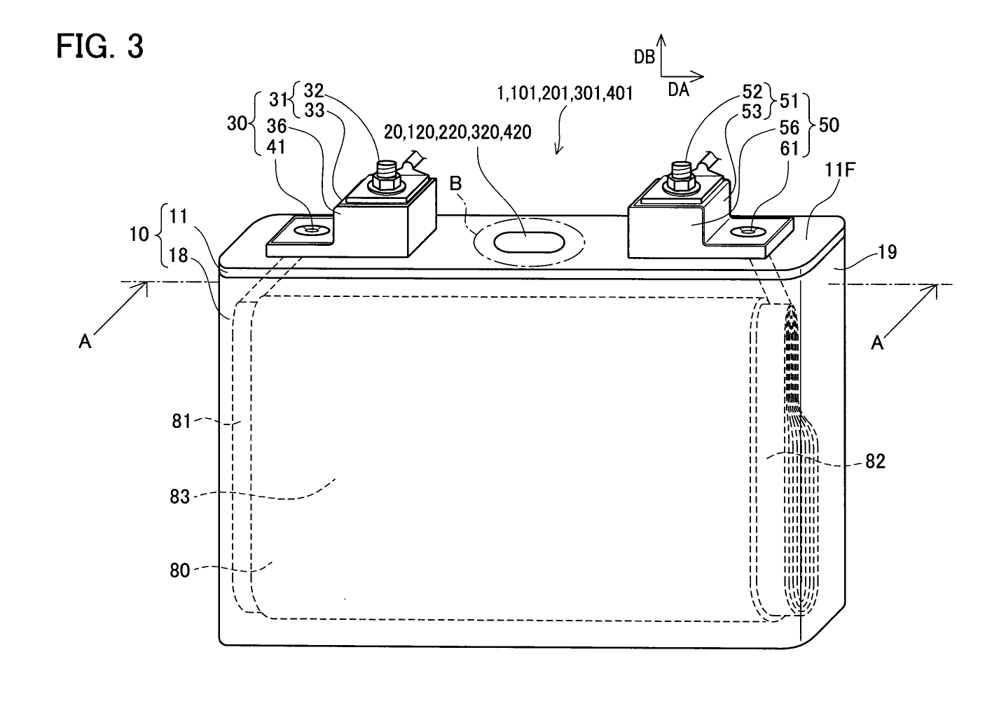

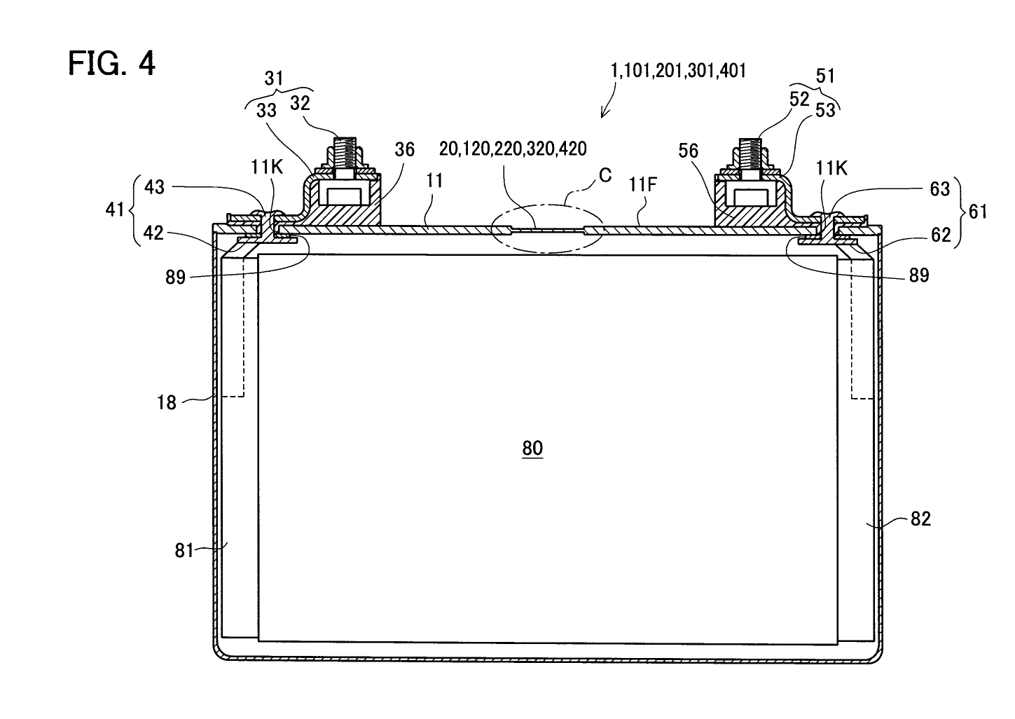

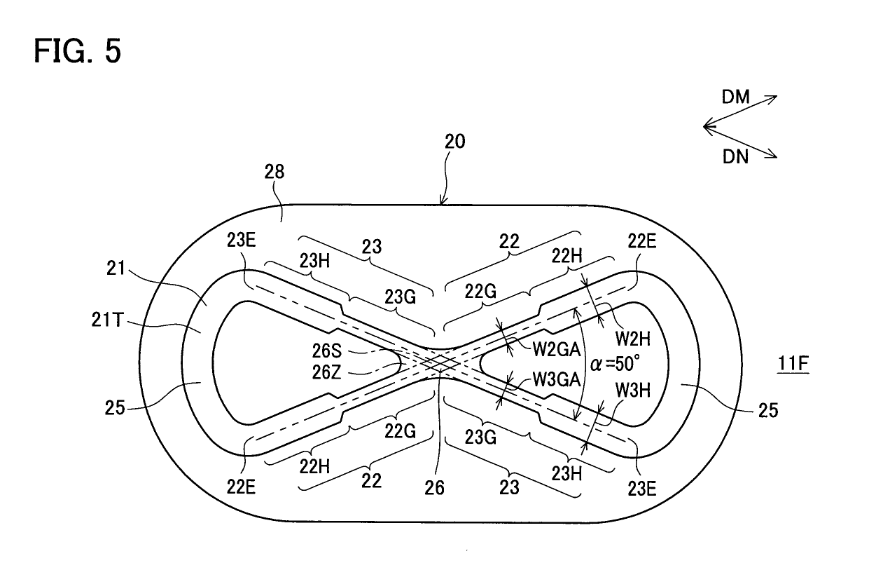

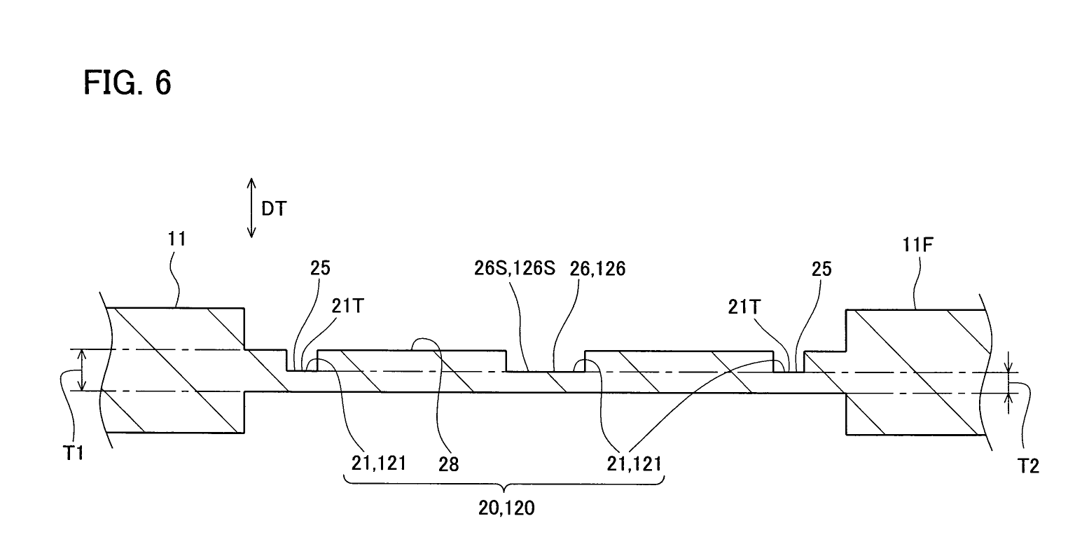

A battery 1 in Embodiment 1 is explained first. FIG. 3 is a perspective view of the battery 1, FIG. 4 is a longitudinal cross sectional view (taken along a line A-A in FIG. 3) of this battery 1, FIG. 5 is an enlarged plan view of a safety valve part (a part B in FIG. 3) of the battery 1, and FIG. 6 is an enlarged cross sectional view of a part of the safety valve part (a part C in FIG. 4) of the battery 1.

This battery 1 is a sealed lithium ion secondary battery including a power generating element 80 and a battery case 10 having a rectangular box-like shape hermetically containing the power generating element 80. This element 80 is formed by winding a strip-shaped positive electrode plate 81 and a strip-shaped negative electrode plate 82 into a flat shape while interposing therebetween a strip-shaped separator 83 (see FIG. 3). The positive electrode plate 81 is configured such that positive active material layers not shown are carried on both surfaces of an aluminum foil and the negative electrode plate 82 is configured such that negative active material layers not shown are carried on both surfaces of a copper foil. The positive electrode plate 81 and the negative electrode plate 82 of the power generating element 80 are joined to a positive inner terminal member 41 and a negative inner terminal member 61 mentioned later, respectively (see FIG. 4).

Further, the battery case 10 includes a bottom-closed box-like case body 18 formed with an opening 19 and a rectangular plate-like closing lid (“lid”) 11, each of which is made of aluminum (see FIG. 3). There is interposed an insulating film made of resin (not shown) between the case body 18 and the power generating element 80 housed therein to prevent leakage of current.

The lid 11 is placed to close the opening 19 of the case body 18 and welded to the case body 18. The lid 11 includes through holes 11K in which the positive inner terminal member 41 and the negative inner terminal member 61 are inserted respectively and a safety valve part 20 formed between them (see FIGS. 3 and 4).

On an outer surface 11F directed outside (upward in FIG. 3), of the lid 11, a positive terminal assembly 30 and a negative terminal assembly 50 are placed respectively (see FIG. 3). The positive terminal assembly 30 includes a positive outer terminal member 31 made of metal, the positive inner terminal member 41 mainly located inside the battery case 10, and a first terminal insulating member 36 made of insulating resin (see FIGS. 3 and 4).

The positive inner terminal member 41 made of aluminum is joined to the positive electrode plate 81 of the power generating element 80 in the battery case 10. On the other hand, the terminal member 41 is electrically connected to the positive outer terminal member 31 while fastening the battery case 10, the outer terminal member 31, and a gasket 89 by caulking or riveting.

The positive outer terminal member 31 made of metal includes a positive terminal portion 32 having a bolt-shaped end and a positive joint plate 33 bent in a crank-like shape and placed in contact with the positive terminal portion 32 (see FIG. 4).

The first insulating member 36 made of insulating resin is interposed between the positive outer terminal member 31 and the lid 11 (see FIGS. 3 and 4) to insulate them.

The gasket 89 is placed between the lid 11 and an inner terminal main part 42 of the positive inner terminal member 41 to prevent entrance of water or foreign substances into the battery case 10 and leakage of an electrolyte out of the battery case 10 (see FIG. 4).

Further, the negative terminal assembly 50, as with the positive terminal assembly 30, includes a negative outer terminal member 51 made of metal, a negative inner terminal member 61 mainly located inside the battery case 10, and a second terminal insulating member 56 made of insulating resin (see FIGS. 3 and 4).

The safety valve part 20 formed near the center of the lid 11 includes, as shown in FIG. 5, a plate-like part 28 having an elliptic shape and a groove-shaped thin-walled portion 21 placed within the plate-like part 28 and formed in an almost 8-like shape and thinner than the plate-like part 28. This safety valve part 20 will be opened in such a manner that the thin-walled portion 21 is cracked to open the safety valve part 20, the split plate-like part 28 is deformed so that each piece is curled up, causing an opening to appear. This safety valve part 20 is a non-recovering type that will loses a safety valve function once opened.

In the safety valve part 20, the plate-like part 28 is thinner than other portions of the lid 11 so that the plate-like part 28 is recessed than the outer surface 11F and the back surface 11R thereof.

On the other hand, the thin-walled portion 21 is a groove recessed so as to be lower than the plate-like part 28 in FIG. 6. Thickness T2 of the thin-walled portion 21 in a thickness direction DT is thinner than thickness T1 of the plate-like part 28.

This thin-walled portion 21 is designed to include a first-direction thin-walled portion 22 extending straight in a first direction DM and a second-direction thin-walled portion 23 extending straight in a second direction DN different from the first direction DM when the outer surface 11F is seen in a plan view (see FIG. 5). Those first-direction thin-walled portion 22 and second-direction thin-walled portion 23 intersect in an X-shape to form a diamond-shaped intersecting thin-walled portion 26S. Further, this thin-walled portion 21 includes two C-shaped thin-walled portions 25 and four wedged thin-walled portions 26Z as shown in FIG. 5 in addition to the above first-direction thin-walled portion 22 and the second-direction thin-walled portion 23. The wedged thin-walled portions 26Z correspond to corners defined between the first-direction thin-walled portion 22 and the second-direction thin-walled portion 23. Each C-shaped thin-walled portion 25 joins ends 22E of the first-direction thin-walled portion 22 and ends 23E of the second-direction thin-walled portion 23. The wedged thin-walled portions 26Z, in cooperation with a part of the first-direction thin-walled portion 22 and a part of the second-direction thin-walled portion 23, constitute an intersecting region 26 shown in FIG. 5.

Herein, the portions of the thin-walled portion 21 excepting the intersecting portion 26S, that is, a part of the first-direction thin-walled portion 22, a part of the second-direction thin-walled portion 23, the wedged thin-walled portions 26, and the C-shaped thin-walled portions 25, are referred to as a non-intersecting thin-walled portion 21T.

In Embodiment 1, as shown in FIG. 5, a first intersection-near portion 22G including the intersecting thin-walled portion 26S in the first-direction thin-walled portion 22 has a groove width W2GA smaller than a groove width W2H of other portions excepting the first intersection-near portion 22G, that is, each of first outside portions 22H located on both sides of the first intersection-near portion 22G. Specifically, the first-direction thin-walled portion 22 is designed so that the first intersection-near portion 22G is narrower than the other, first outside portions 22H.

Further, the second-direction thin-walled portion 23 is designed, as with the first-direction thin-walled portion 22, so that a groove width W3GA of a second intersection-near portion 23G including the intersecting thin-walled portion 26S is smaller than a groove width W3H of other portions than the second intersection-near portion 23G, that is, each of second outside portions 23H located on both sides of the second intersection-near portion 23G, as shown in FIG. 5. Specifically, the second-direction thin-walled portion 23 is designed so that the second intersection-near portion 23G is narrower than the other, second outside portions 23H.

Meanwhile, as described above, if a wedged thin-walled portion 26Z is first to start to cleave to open the safety valve part 20, any portion(s) of the first-direction thin-walled portion 22 and the second-direction thin-walled portion 23 extending in four directions may not be cracked and thus cleaving is not advanced. In this case, a sufficient opening area of the safety valve part 20 could not be ensured by cleaving.

Therefore, the inventors studied a relationship between a cleaving start point and an intersecting angle α between the first-direction thin-walled portion 22 and the second-direction thin-walled portion 23 in the intersecting thin-walled portion 26S and then found that when the intersecting angle α was set in a predetermined range, it was easy to start cleaving from the thin-walled portion 26S.

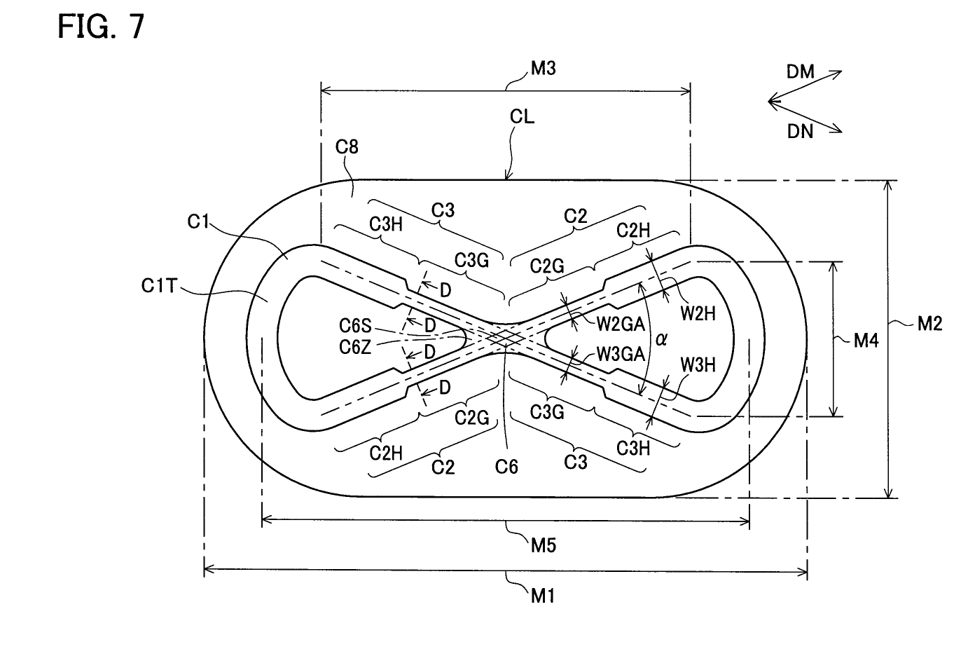

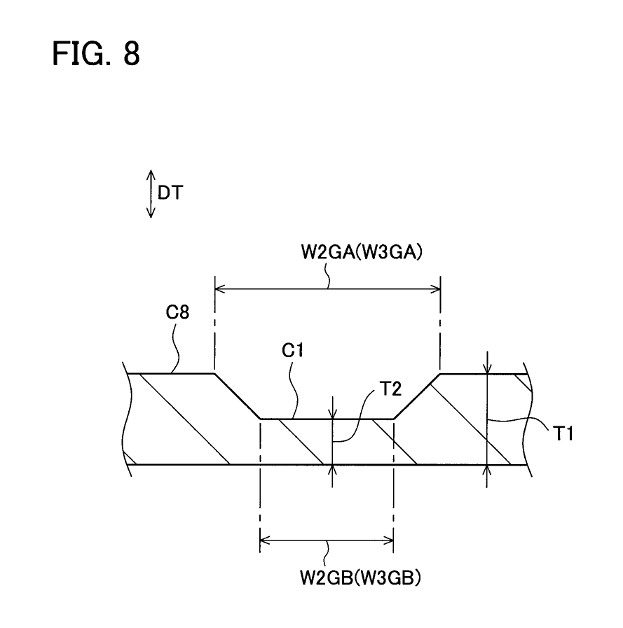

Specifically, CAE (Computer Aided Engineering) analysis and statistical analysis were carried out on a safety valve part CL as a model as shown in FIGS. 7 and 8. To be more concrete, the safety valve part CL made of aluminum (stress intensity factor: 25 M (Nm^{-3/2})) was produced such that the thickness T1 of a plate-like part C8 is 0.12 mm and the thickness T2 of a thin-walled portion C1 is 0.04 mm in order to set a cleavage pressure of an intersecting thin-walled portion C6S to 1.2 MPa. Further, a first intersection-near portion C2G of the first-direction thin-walled portion C2 was designed so that a first groove width W2GA opening on the plate-like part C8 was 0.17 mm and a second groove width W2GB of the thin-walled portion C1 was 0.05 mm. Even though not shown in the figure, a first groove width W3GA and a second groove width W3GB of a second intersection-near portion C3G of the second-direction thin-walled portion C3 were set to 0.17 mm and 0.05 mm respectively as with the first intersection-near portion C2G. Further, the cleavage pressure (1.2 MPa) of the intersecting thin-walled portion C6S is a lower value than the cleavage pressure of each non-intersecting thin-walled portion C1T of the thin-walled portion C1.

When the cleavage pressure of the intersecting thin-walled portion C6S of this safety valve part CL, that is, the stress that presses the intersecting thin-walled portion C6S of the safety valve part CL is assumed as σ₀, the following relational expression is established. Thus, based on this expression, the thickness T1 of the plate-like part C8 and the thickness T2 of the thin-walled portion C1 were determined.

σ₀=K/(F(λ)×((T1−T2) π) ^{½})

F(λ)=1.12−0.231λ+10.55λ²−21.72λ³+30.39λ⁴

λ=(T1−T2)/T1

K: Stress intensity factor

This safety valve part CL was first subjected to the CAE analysis to examine the stress distribution of the entire safety valve part CL. The examination result reveals that in the intersecting thin-walled portion C6S, as the intersecting angle α is close to 0°, stress concentration is effectively caused, thus facilitating cleaving.

However, the result also reveals that, since the first-direction thin-walled portion C2 and the second-direction thin-walled portion C3 have the groove widths W2GA and W3GA respectively, as the intersecting angle α is close to 0°, a wedged thin-walled portion C6Z is apt to split off.

The inventors therefore made the statistical analysis on experimental data obtained by using various intersecting angles a in relation to the cleavage pressure and strength of the intersecting thin-walled portion C6S.

From the result of this statistical analysis, it was found that for the intersecting angle α in a range of 30° to 50°, the cleavage pressure of the intersecting thin-walled portion C6S of the safety valve part CL was stable and became lower than that of the non-intersecting thin-walled portion C1T. Accordingly, it was found that cleaving could be easily started from this intersecting thin-walled portion C6S.

Based on such findings, in the range of 30° to 50°, the intersecting angle α in Embodiment 1 is set to 50° (see FIG. 5).

Sizes of the safety valve part CL with the intersecting angle α of 50° in Embodiment 1 are as determined as follows. In the plate-like part C8 of the safety valve part CL shown in FIGS. 7 and 8, a first size M1 in a long side direction (a horizontal direction in FIG. 7) is 15 mm and a second size M2 in a short side direction (a vertical direction in FIG. 7) is 7 mm. A third size M3 of the first-direction thin-walled portion C2 (and the second-direction thin-walled portion C3) in the horizontal direction in FIG. 7 is 8 mm, a fourth size M4 of the first-direction thin-walled portion C2 (and the second-direction thin-walled portion C3) in the vertical direction in FIG. 7 is 4 mm, and a fifth direction M5 of the thin-walled portion C1 in the horizontal direction in FIG. 7 is 12 mm. Although the thickness T1 of the plate-like part C8 in Embodiment 1 is 0.12 mm and the thickness T2 of the thin-walled portion C1 is 0.04 mm, the thickness T1 of the plate-like part C8 may be selected in a range of 0.11 mm to 0.14 mm and the thickness T2 of the thin-walled portion C1 may be selected in a range of 0.03 mm to 0.05 mm.

The safety valve part CL having the above sizes can reliably make the intersecting thin-walled portion C6S cleave first at a cleavage pressure of about 1.2 MPa (±0.4 MPa), thereby ensuring a sufficient opening of the safety valve part CL.

Accordingly, in the battery 1 of Embodiment 1, the safety valve part 20 is configured such that the cleavage pressure of the intersecting thin-walled portion 26S is lower than the cleavage pressure of the non-intersecting thin-walled portion 21T. Specifically, the intersecting angle α between the first-direction thin-walled portion 22 and the second-direction thin-walled portion 23 is determined in a range of 30°≦α≦50°. At the time of opening the safety valve part 20, it is consequently possible to surely start the cleaving from the intersecting thin-walled portion 26S and advance the cleaving in an X shape along the first-direction thin-walled portion 22 and the second-direction thin-walled portion 23 extending in four directions from the intersecting thin-walled portion 26S. Consequently, when opened, the safety valve part 20 can provide a sufficient opening area.

Further, the first-direction thin-walled portion 22 includes the first intersection-near portion 22G narrower than the other portions (the first outside portions 22H). The second-direction thin-walled portion 23 includes the second intersection-near portion 23G narrower than the other portions (the second outside portions 23H). This configuration can make it easy to concentrate stress on the intersecting thin-walled portion 26S of the thin-walled portion 21 when the safety valve part 20 is to be opened, thereby enabling the cleaving beginning with the intersecting thin-walled portion 26S.

Furthermore, the first outside portions 22H of the first-direction thin-walled portion 22 other than the first intersection-near portion 22G are designed with the groove width W2H wider than the groove width W2GA of the first intersection-near portion 22G (W2H>W2GA). The second outside portions 23H of the second-direction thin-walled portion 23 other than the second intersection-near portion 23G are designed with the groove width W3H wider than the groove width W3GA of the second intersection-near portion 23G (W3H>W3GA). Such configuration can make the cleaving having advanced from the intersecting thin-walled portion 26S easily further go on in the first outside portions 22H and the second outside portions 23H. Thus, the safety valve part 20 can surely ensure a sufficient opening area.

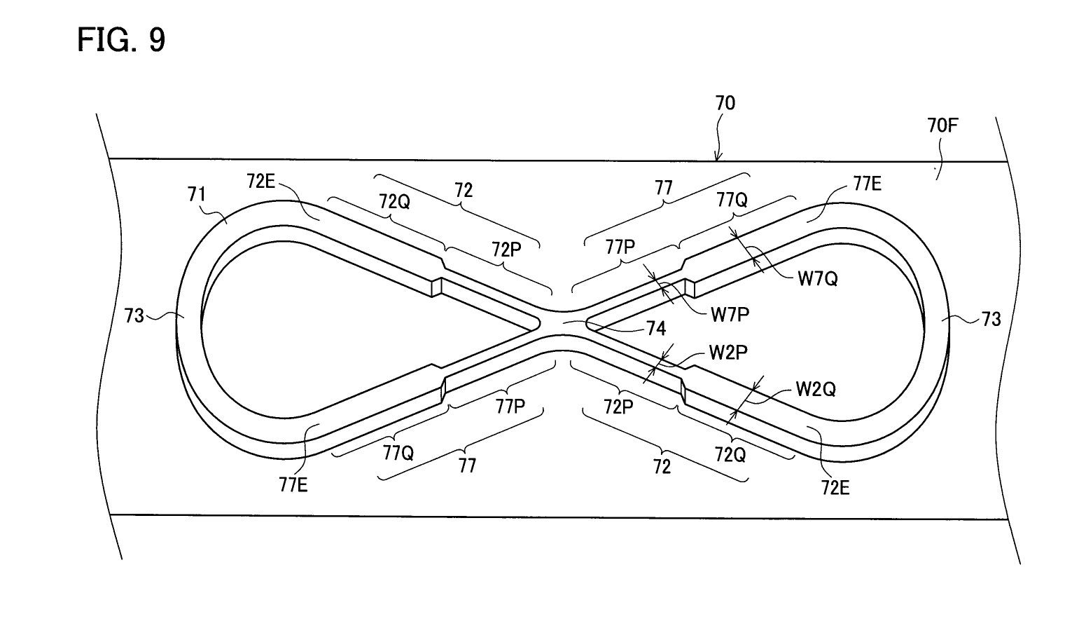

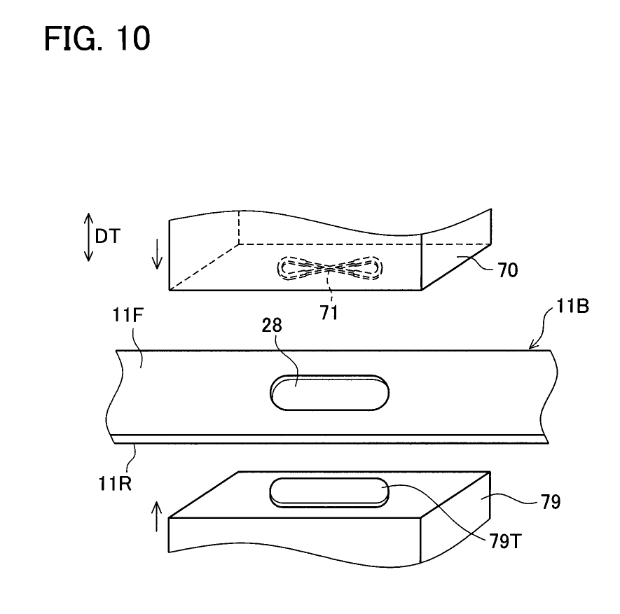

A method of producing the battery 1 of Embodiment 1 will be described below referring to FIGS. 9 and 10.

The producing method of this battery 1 includes a press process in which an unprocessed safety valve part 20B which is not yet formed with a thin-walled portion 21 is subjected to a single press work to simultaneously form the first-direction thin-walled portion 22, the second-direction thin-walled portion 23, and the aforementioned intersecting region 26 in the plate-like part 28.

A first press die 70 used in this press process is first explained. This first press die 70 is formed with a press blade 71 having an almost 8-like shape including straight blade portions intersecting like an X shape as shown in FIG. 9. This press blade 71 of the first press die 70 is configured such that a first straight press blade portion 72 and a second straight press blade portion 77 each having a straight strip shape intersect at an intersecting portion 74, and the first and second straight press blade portions 72 and 77 and the intersecting portion 74 protrude upward from a surface 70F of the first press die 70 in FIG. 9. This press blade 71 includes, in addition to the above first and second straight press blade portions 72 and 77, two C-shaped curved press blade portions 73 joining both ends 72E of the first straight press blade portion 72 to both ends 77E of the second straight press blade portion 77. The press blade 71 is formed by use of a machining tool and thus the intersecting portion 74 is formed with round corners as shown in FIG. 9.

In this press blade 71, a blade width W2P of a first intersection-near portion 72P of the first straight press blade portion 72 including the intersecting portion 74 is designed to be narrower than a blade width W2Q of first outside portions 72Q located both outside the first intersection-near portion 72P as shown in FIG. 9.

Further, a blade width W7P of a second intersection-near portion 77P of the second straight press blade portion 77 including the intersecting portion 74 is designed to be narrower than a blade width W7Q of second outside portions 77Q located both outside the second intersection-near portion 77P.

The press process will be explained below.

A rectangular plate-like unprocessed closing lid 11 which is not yet formed with a thin-walled portion 21 is prepared in advance (see FIG. 10). This lid 11B is previously formed with a plate-like part 28 that is thinner than other portions of the lid 11B and is recessed lower than the outer surface 11F and the back surface 11R.

The above lid 11B is subjected to the press process by use of the aforementioned first press die 70 and a third press die 79 having a protrusion 79T which will come into contact with the recessed plate-like part 28.

Specifically, on both sides of the unprocessed lid 11B, the first press die 70 is placed on the outer surface 11F side (upper side in FIG. 10) of the lid 11B and the third press die 79 is placed on the back surface 11R side (lower side in FIG. 10), respectively. Thereafter, the first and third press dies 70 and 79 are moved close to each other in the thickness direction DT to press the lid 11B.

By this press process, the safety valve part 20 is completed in which the plate-like part 28 is formed with the thin-walled portion 21 on the outer surface 11F side (see FIG. 5). Specifically, this thin-walled portion 21 includes the first-direction thin-walled portion 22 extending straight in the first direction DM and the second-direction thin-walled portion 23 extending straight in the second direction DN. Further, there are included the intersecting region 26 and two C-shaped thin-walled portions 25. The intersecting region 26 is defined by a part of the first-direction thin-walled portion 22, a part of the second-direction thin-walled portion 23, and four wedged thin-walled portions 26Z. The intersecting thin-walled portion 26S is a portion in which a part of the first-direction thin-walled portion 22 and a part of the second-direction thin-walled portion 23 overlap.

In Embodiment 1, the intersecting angle α between the first-direction thin-walled portion 22 and the second-direction thin-walled portion 23 of the thin-walled portion 21 is set to 50°.

In a separate process, a positive electrode plate 81 and a negative electrode plate 82, each having a strip shape, are wound by interposing a separator 83 therebetween, thereby forming a power generating element 80. Thereafter, an inner terminal member 41 is welded to the positive electrode plate 81 and an inner terminal member 61 is welded to the negative electrode plate 82. The positive terminal assembly 30 and the negative terminal assembly 50 are placed on the lid 11 so that the lid 11, the power generating element 80, the positive terminal assembly 30, and the negative terminal assembly 50 are integrally assembled.

After the power generating element 80 is housed in the case body 18 and an electrolyte not shown is poured into the case body 18, the lid 11 is welded to the case body 18 for sealing. The battery 1 is thus completed (see FIG. 3).

### Modified Example 1

A battery 101 in Modified example 1 of the invention will be explained below referring to FIGS. 3, 4, 6, and 11.

This Modified example 1 is similar to Embodiment 1 excepting that a safety valve part includes an intersecting thin-walled portion but does not include a wedged thin-walled portion, that is, the aforementioned intersecting region is entirely an intersecting thin-walled portion.

The following explanation is therefore given with a focus on differences from Embodiment 1. Identical or similar parts to those in Embodiment 1 are not explained or are briefly mentioned. Such identical or similar parts will provide the same operations and advantages as in Embodiment 1. The identical or similar parts are described below with the same reference signs as those in Embodiment 1.

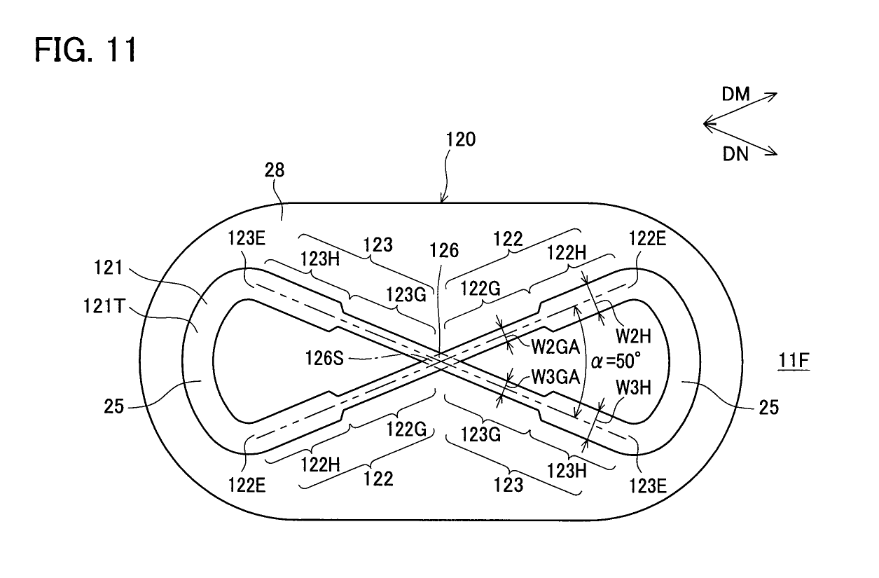

A safety valve part 120 of Modified example 1 includes, as shown in FIG. 11, an elliptical plate-like part 28 and a groove-shaped thin-walled portion 121 located within this plate-like part 28 and formed in an almost 8-like shape and thinner than the plate-like part 28. The plate-like part 28 is formed thinner than other portions of a closing lid 11 and recessed lower than an outer surface 11F and a back surface 11R (see FIG. 6) in a similar manner to those in Embodiment 1.

On the other hand, the thin-walled portion 121 is a groove recessed lower than the plate-like part 28 in FIG. 6. The thickness T2 of the thin-walled portion 121 in the thickness direction DT is thinner than the thickness T1 of the plate-like part 28.

This thin-walled portion 121 includes a first-direction thin-walled portion 122 and a second-direction thin-walled portion 123 as in Embodiment 1. Those thin-walled portions 122 and 123 intersect in an X shape, forming an intersecting thin-walled portion 126S. The thin-walled portion 121 further includes two C-shaped thin-walled portions 25 as in Embodiment 1. Other portions of the thin-walled portion 121 excepting the intersecting thin-walled portion 126S (a part of the first-direction thin-walled portion 22, a part of the second-direction thin-walled portion 23, and the C-shaped thin-walled portions 25) are referred to as a non-intersecting thin-walled portion 121T.

As with Embodiment 1, furthermore, in the first-direction thin-walled portion 122, a first inner range 122G is narrower than other first outer ranges 122H. In the second-direction thin-walled portion 123, a second inner range 123G is narrower than other second outer ranges 123H.

The first-direction thin-walled portion 122 and the second-direction thin-walled portion 123 are produced one after the other in a two-stage press process (a first press process and a second press process). Accordingly, unlike Embodiment 1, the thin-walled portion 121 includes a diamond-shaped intersecting thin-walled portion 126S in which the first-direction thin-walled portion 122 and the second-direction thin-walled portion 123 overlap but does not include a wedged thin-walled portion (see FIG. 11).

In the safety valve part 120 of the battery 101 in this Modified example 1, the intersecting angle α between the first-direction thin-walled portion 122 and the second-direction thin-walled portion 123 is set to 50° (see FIG. 9) as in Embodiment 1. In Modified example 1, however, the intersecting region 126 of the safety valve part 120 is entirely the intersecting thin-walled portion 126S, and the intersecting region 126 does not include a thin-walled portion. Thus, even if Modified example 1 does not limit the intersecting angle a as in Embodiment 1, the cleavage pressure of the intersecting thin-walled portion 126S is lower than that of the non-intersecting thin-walled portion 121T. Accordingly, at the time of opening the safety valve part 120, it is possible to start cleaving from the intersecting thin-walled portion 126S and advance the cleaving in an X shape along the first-direction thin-walled portion 122 and the second-direction thin-walled portion 123 extending in four directions from the intersecting thin-walled portion 126S.

Meanwhile, the inventors also performed the CAE analysis and the statistical analysis as in Embodiment 1 in relation to a configuration (corresponding to the configuration in FIG. 11) obtained by removing the wedged thin-walled portion C6Z from the intersecting thin-walled portion C6 of the safety valve part CL shown in FIGS. 7 and 8. The analysis results reveal that the cleavage pressure of the intersecting thin-walled portion C6S in the safety valve part with no wedged thin-walled portion C6Z becomes stable when the intersecting angle α is in a range of 30° to 50°.

From the above results, irrespective of the presence/absence of the wedged thin-walled portion C6Z in the intersecting thin-walled portion C6, the cleavage pressure of the intersecting thin-walled portion C6S of the safety valve part CL is stable for the intersecting angle α in a range of 30° to 50°. Thus, the cleavage pressure of the intersecting thin-walled portion C6S is lower than that of the non-intersecting thin-walled portion C1T. Consequently, it is found that the intersecting thin-walled portion C6 could easily start to cleave earlier than the non-intersecting thin-walled portion C1T.

Based on such findings, Modified example 1 is also configured so that the intersecting angle α is 50° in a range of 30° to 50°. Accordingly, at the time of opening the safety valve part, it is possible to more reliably start cleaving from the intersecting thin-walled portion 126S (the intersecting region 126).

Next, a method of producing the battery 101 of Modified example 1 will be described referring to FIGS. 11 to 14.

This producing method of the battery 101 includes a first press process which is applied to an unprocessed safety valve part 120B which is not yet formed with a thin-walled portion 121 to form a first-direction thin-walled portion in a plate-like part 28 by a press work and, following this first press process, a second press process to form a second-direction thin-walled portion in the plate-like part 28 by another press work.

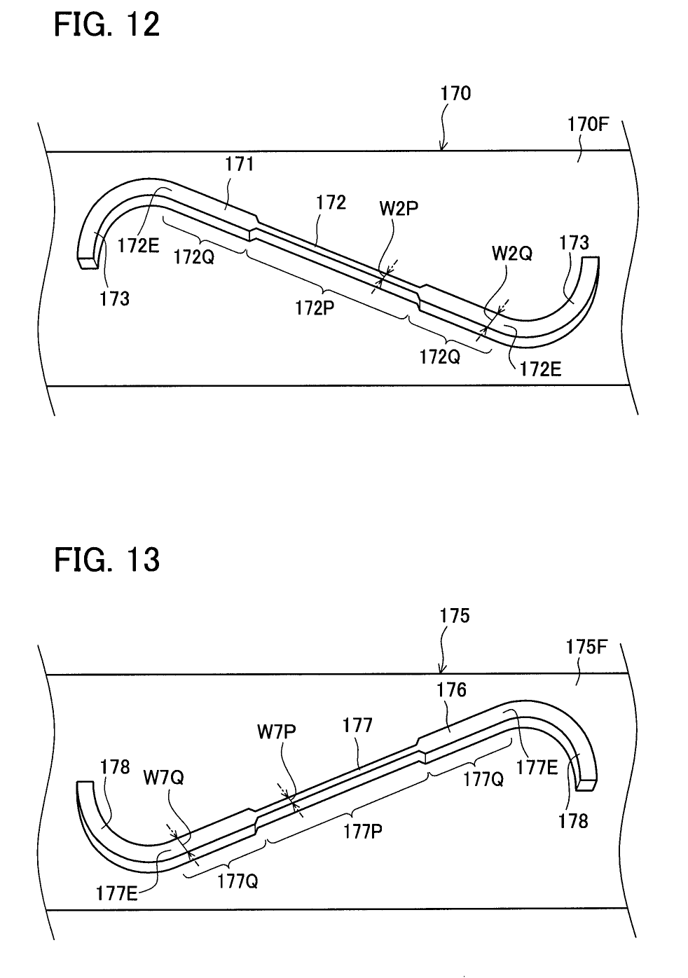

A first press die 170 used in the first press process is first explained. This die 170 is formed with a press blade 171 having an almost S-shaped configuration and protruding in a rectangular form from a flat surface 170F as shown in FIG. 12. The press blade 171 of the first press die 170 includes a first straight press blade portion 172 extending straight and C-shaped first curved press blade portions 173 continuous to ends 172E of the first straight blade portion 172. This press blade 171 is designed as shown in FIG. 12 such that a groove width W2P of a first inner range 172P including the vicinity of the center of the first straight blade portion 172 is narrower than a groove width W2Q of first outer ranges 172Q located on both sides of the first inner range 172P.

On the other hand, in the second press process, a second press die 175 shown in FIG. 13 is used, in which a press blade 176 having an almost S shape and protruding in a rectangular form from a flat surface 175F. The press blade 176 of this die 175 includes a second straight press blade portion 177 extending straight and C-shaped second curved press blade portions 178 continuous to ends 177E of the second straight blade portion 177, as with the first press die 170. This press blade 176 is designed as shown in FIG. 13 such that a groove width W7P of a second inner range 177P including the vicinity of the center of the second straight blade portion 177 is narrower than a groove width W7Q of a second outer range 177Q located both outside the second inner range 177P.

The first and second press processes are explained below.

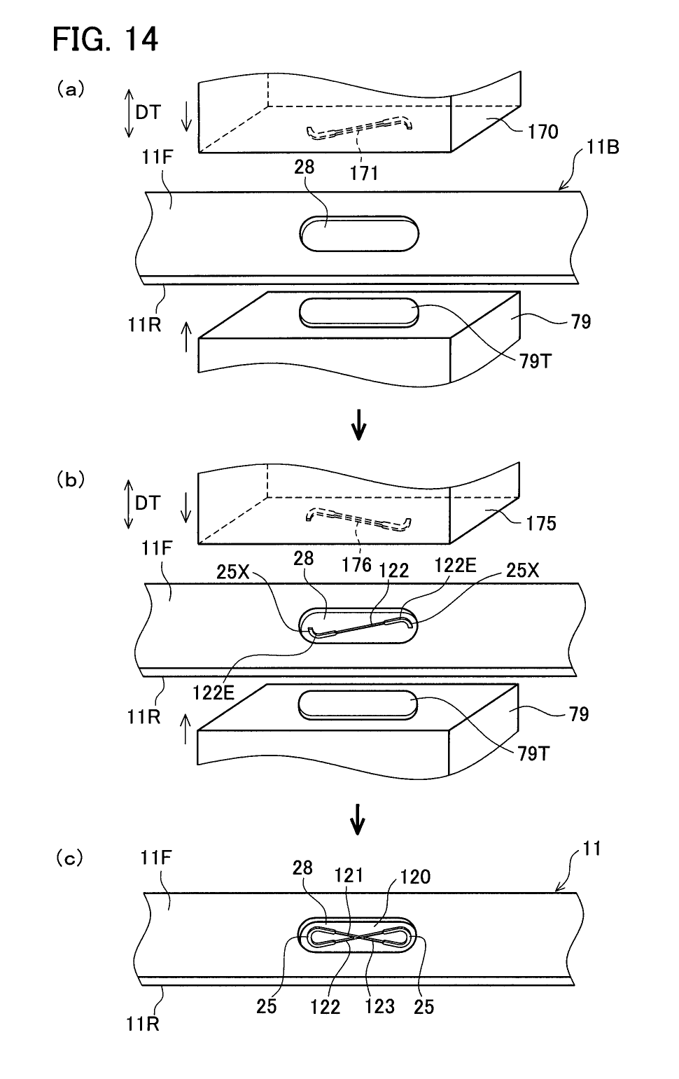

A rectangular plate-like unprocessed closing lid 11B which is not yet formed with a thin-walled portion is prepared in advance. This lid 11B is previously formed with a plate-like part 28 that is thinner than other portions of the lid 11B and is recessed lower than an outer surface 11F and a back surface 11R (see FIG. 14(a)).

The lid 11B is subjected to the first press process using the aforementioned first press die 170 and a third press die 79 similar to that in Embodiment 1, the die 79 including a protrusion 79T which will come into contact with the recessed plate-like part 28.

Specifically, on both sides of the unprocessed lid 11B, the first press die 170 is placed on the outer surface 11F side (upper side in FIG. 14(a)) of the lid 11B and the third press die 79 is placed on the back surface 11R side (lower side in FIG. 14(a)), respectively. Thereafter, the first and third press dies 170 and 79 are moved close to each other in the thickness direction DT to press the lid 11B.

By this press process, a part of the thin-walled portion 121 mentioned above is formed in the plate-like part 28 on the outer surface 11F side. Specifically, the first-direction thin-walled portion 122 extending straight in the first direction DM and half of each C-shaped thin-walled portion 25 continuous to the ends 122E of the first-direction thin-walled portion 122, referred to as a half C-shaped thin-walled portion 25X, are formed in the shape of a groove recessed lower than the plate-like part 28 (see FIG. 14(b)).

Following the first press process, the second press process is conducted by using the second press die 175 and the third press die 79.

Specifically, the second press die 175 is placed on the outer surface 11F side formed with a part of the thin-walled portion 121 and the third press die 79 is placed on the back surface 11R side (see FIG. 14(b)) respectively. Thereafter, the second and third press dies 175 and 79 are moved close to each other in the thickness direction DT to press the lid 11B.

Thus, the thin-walled portion 121 is formed in the plate-like part 28 on the outer surface 11F side. In other words, this thin-walled portion 121 includes a first-direction thin-walled portion 122 extending straight in the first direction DM and a second-direction thin-walled portion 123 extending straight in the second direction DN, and further two C-shaped thin-walled portions 25. Those first-direction thin-walled portion 122 and second-direction thin-walled portion 123 intersect in an X shape, forming an intersecting thin-walled portion 126S (see FIG. 14(c)).

As above, the safety valve part 120, i.e., the groove-shaped thin-walled portion 121 formed in an almost 8-like shape and thinner than the plate-like part 28 is formed near the center of the lid 11 (see FIG. 11). The intersecting angle a between the first-direction thin-walled portion 122 and the second-direction thin-walled portion 123 of the thin-walled portion 121 is 50°.

The Modified example 1 has a distinctive characteristic in that a means (method) of physically reducing the area (or the volume) of the wedged thin-walled portion is realized by the producing process including no step of forming the wedged thin-walled portion itself. In the producing method of the battery 101 mentioned above, specifically, the first-direction thin-walled portion 122 and the second-direction thin-walled portion 123 are formed by the two-stage press process, i.e., the first press process and the second press process. In other words, by use of the first press die 170 formed with the first straight press blade portion 172 extending in a single linear form and the second press die 175 formed with the second straight press blade portion 177 extending in a single linear form, the first-direction thin-walled portion 122 and the second-direction thin-walled portion 123 including the intersecting thin-walled portion 126S are produced. Such a press process performed in two stages can achieve a configuration that the intersecting thin-walled portion 126S includes no wedged thin-walled portion mentioned above. Accordingly, at the time of opening the safety valve part 120, it is possible to start cleaving from the intersecting thin-walled portion 126S and advance the cleaving in an X shape along the first-direction thin-walled portion 122 and the second-direction thin-walled portion 123 extending in four directions from the intersecting thin-walled portion 126S. Consequently, the battery 101 capable of ensuring a sufficient opening area can be produced.

It is to be noted that the press process consisting of the first press process and the second press process in this Modified example 1 corresponds to a linear thin-walled portion forming process of the invention.

### Modified Example 2

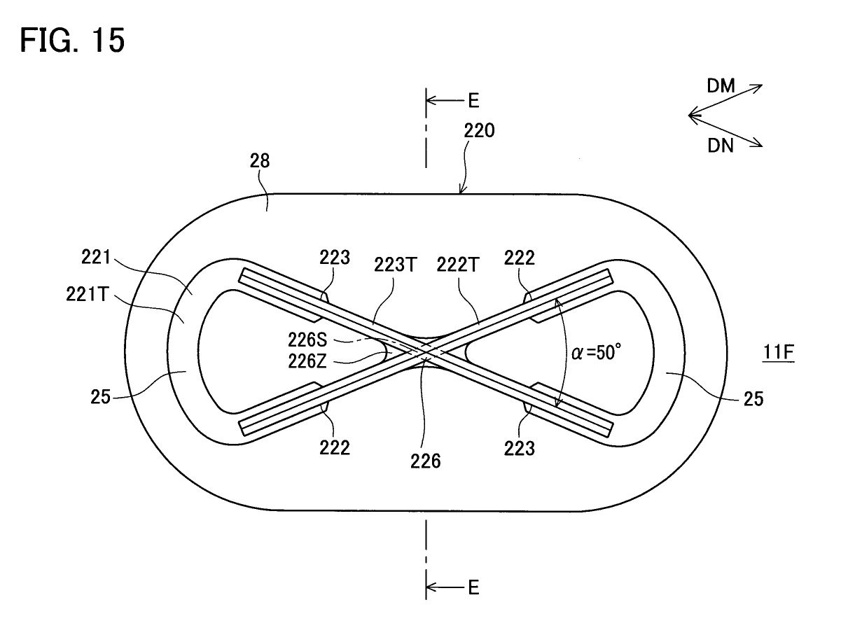

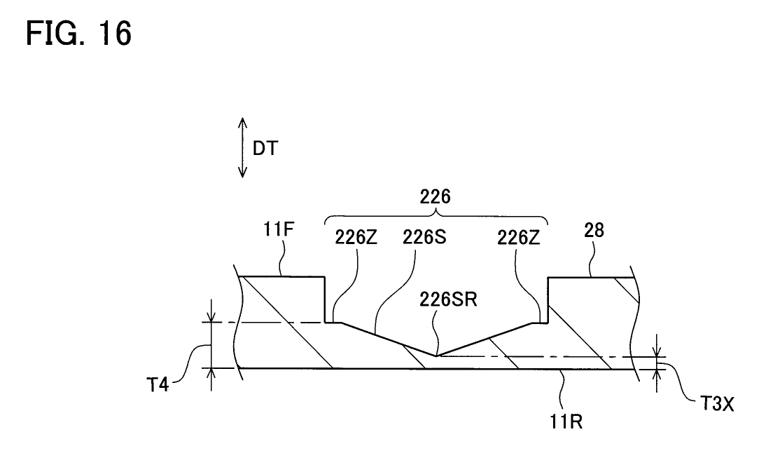

A battery 201 of Modified example 2 of the invention will be described below referring to FIGS. 15 and 16.

This Modified example 2 is similar to Embodiment 1 excepting in that a part of an intersecting thin-walled portion is formed thinner than other portions of the intersecting thin-walled portion itself.

To be concrete, a first-direction thin-walled portion 222 of a thin-walled portion 221 includes a first tapered portion 222T which is tapered downward so that its center point in a width direction is most deeply recessed in a cross section orthogonal to a first direction DM in FIG. 15. A second-direction thin-walled portion 223 similarly includes a second tapered portion 223T which is tapered downward so that its center point in a width direction is most deeply recessed in a cross section orthogonal to a second direction DN, as with the first-direction thin-walled portion 222.

Those first and second tapered portions 222T and 223T intersect each other in an intersecting region 226, forming an intersecting thin-walled region 226. Therefore, as shown in FIG. 16 showing a cross section taken along a line E-E in FIG. 15, an intersecting thin-walled portion 226S is configured such that thin-walled bottom portions 226SR each being recessed in a V shape intersect in an X shape. Thus, the thickness T3X of each bottom portion 226SR is thinner than that of a non-intersecting thin-walled portion 221T. Further, the thickness T3X of the bottom portion 226SR is thinner than the thickness T4 of a wedged thin-walled portion 226Z of the intersecting region 226 as shown in FIG. 16.

In general, as the thickness of a portion is thinner, the cleavage pressure of that portion is lower. Accordingly, it is found that a safety valve part 220 of Modified example 2 is configured to make the bottom portion 226SR of the intersecting thin-walled portion 226 easier to cleave than the wedged thin-walled portion 226Z of the intersecting region 226.

In the battery 201 of Modified example 2, consequently, at the time of opening the safety valve part 220, it is possible to reliably start cleaving from the intersecting thin-walled portion 226S of the thin-walled portion 221.

### Modified Example 3

A battery 301 of Modified example 3 of the invention will be explained referring to FIGS. 3, 4, and 17.

The Modified example 3 is different from Embodiment 1 mentioned above in that a thin-walled portion of a safety valve part is constituted of three linear thin-walled portions.

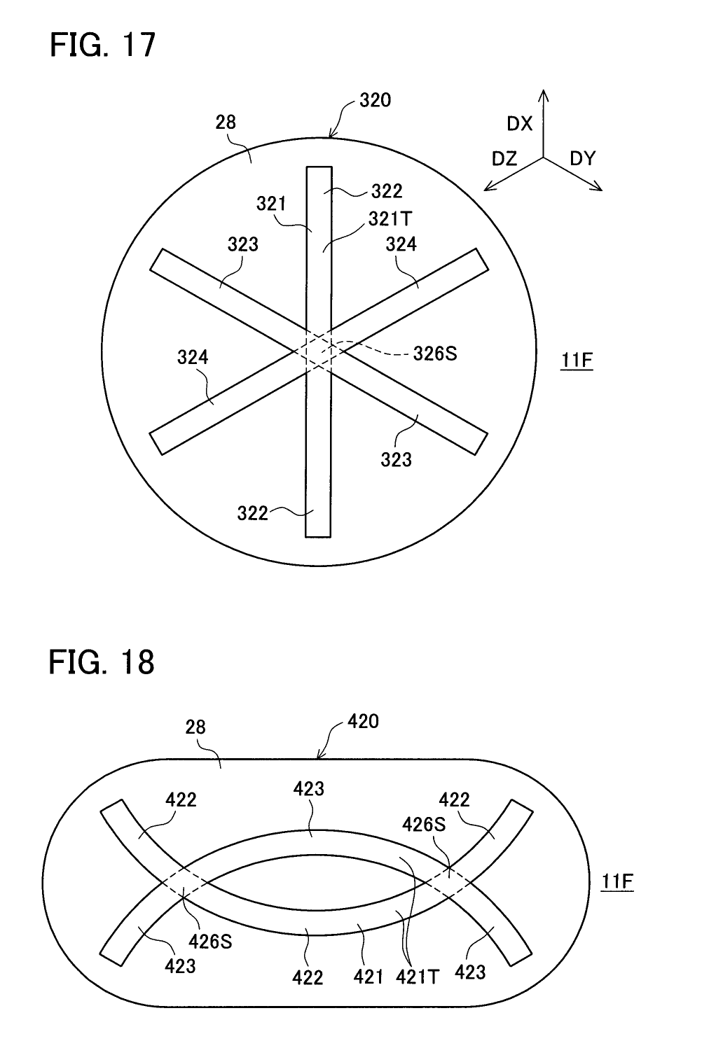

Specifically, a safety valve part 320 of the battery 301 includes a plate-like part 28 and a groove-shaped thin-walled portion 321 located in a plate-like part 28 and formed in an *(asterisk)-shape and thinner than the plate-like part 28 (see FIG. 17).

The thin-walled portion 321 includes a first-direction thin-walled portion 322 extending straight in a first direction DX, a second-direction thin-walled portion 323 extending straight in a second direction DY, and further a third-direction thin-walled portion 324 extending straight in a third direction DZ. Those first-direction thin-walled portion 322, second-direction thin-walled portion 323, and third-direction thin-walled portion 324 intersect one another, forming an *(asterisk)-shaped intersecting thin-walled portion 326S. Other portions of the thin-walled portion 321 excepting the intersecting thin-walled portion 326 are referred to as a non-intersecting thin-walled portion 321T.

A method of producing the battery 301 of Modified example 3 includes a first press process for forming the first-direction thin-walled portion 322 by press work, a second press process for forming the second-direction thin-walled portion 323 after the first press process, and a third press process for forming the third-direction thin-walled portion 324 following the second press process. Therefore, the thin-walled portion 321 does not include such wedged thin-walled portion as disclosed in Embodiment 1 mentioned above. At the time of opening the safety valve part 320, it is therefore possible to reliably start cleaving from the intersecting thin-walled portion 326 of the thin-walled portion 321.

### Modified Example 4

A battery 401 of Modified example 4 of the invention will be described below referring to FIGS. 3, 4, and 18.

This Modified example 4 is different from Embodiment 1 in that each thin-walled portion of a safety valve part is formed of a first curved thin-walled portion and a second curved thin-walled portion each extending in a curved form.

To be concrete, a safety valve part 420 of the battery 401 includes a plate-like part 28 and a groove-shaped thin-walled portion 421 located in the plate-like part 28 and formed thinner than the plate-like part 28 (see FIG. 18).

The thin-walled portion 421 includes a first curved thin-walled portion 422 and a second curved thin-walled portion 423 each extending in an arc-shaped form. Those first and second curved portions 422 and 423 intersect each other at two intersecting thin-walled portions 426S as shown in FIG. 18. It is to be noted that other portions of the thin-walled portion 421 than the intersecting thin-walled portions 426S are referred to as a non-intersecting thin-walled portion 421T.

A method of producing the battery 401 of Modified example 4 includes a first curve press process for forming the first curved thin-walled portion 422 and a second curve press process for forming the second curved thin-walled portion 423 after the first curved press process. Therefore, the thin-walled portion 421 does not such a wedged thin-walled portion as disclosed in Embodiment 1. At the time of opening the safety valve part 420, it is consequently possible to reliably start cleaving from the intersecting thin-walled portions 426 of the thin-walled portion 421.

The present invention is explained in Embodiment 1 and Modified examples 1 to 4 but not limited thereto. The invention may be embodied in other specific forms without departing from the essential characteristics thereof.

For instance, although the thin-walled portions of the safety valve parts in Embodiment 1 and others are formed in an almost 8-like shape, the thin-walled portions may be formed in any shape as long as it is an X shape including the first-direction thin-walled portion, the second-direction thin-walled portion, and the intersecting thin-walled portion formed by intersection of those first-direction thin-walled portion and second-direction thin-walled portion. Accordingly, for example, it may be arranged so that an end of the first-direction thin-walled portion and an end of the second-direction thin-walled portion are not connected through a thin-walled portion.

Although the safety valve parts are produced in the closing lid by press work in Embodiment 1 and others, a safety valve part produced separately from a closing lid may be joined to the closing lid.

In Modified example 3, the first tapered portion is formed over the entire first-direction thin-walled portion and the second tapered portion is formed over the entire second-direction thin-walled portion. As an alternative, for instance, it may be configured such that a first tapered portion is formed only in a first intersection-near portion of the first-direction thin-walled portion and a second tapered portion is formed only in a second intersection-near portion of the second-direction thin-walled portion.

1. A sealed battery comprising:
a power generating element; and
a battery case hermetically housing the power generating element, the battery case including a safety valve part in a valve forming surface, the safety valve part including:
a plate-like part having a predetermined thickness in its own thickness direction; and
a groove-shaped thin-walled portion located within the plate-like part and formed with a thinner thickness than the plate-like part in the thickness direction and configured to cleave at a time of opening the valve part,
wherein the thin-walled portion includes n thin-walled portions (n is an integer more than 2) consisting of first to n-th linear thin-walled portions each linearly extending,
the first to n-th linear thin-walled portions include an intersecting thin-walled portion in which all of the first to n-th thin-walled linear portions intersect each other,
the first to n-th linear thin-walled portions are configured so that, on both sides of a linearly extending narrow portion including the intersecting thin-walled portion, linearly extending portions wider than the linearly extending narrow portion including the intersecting thin-walled portion and longer than a width of the linearly extending narrow portion including the intersecting thin-walled portion are located, and
the thin-walled portion is configured to cleave at a lower cleavage pressure than a cleavage pressure of other portions than the intersecting thin-walled portion.

2. The sealed battery according to claim 1, wherein
the first to n-th thin-walled linear portions are a first-direction thin-walled portion extending in a first direction and a second-direction thin-walled portion extending in a second direction different from the first direction,
the thin-walled portion includes the first-direction thin-walled portion and the second-direction thin-walled portion,
the thin-walled portion is configured so that the first-direction thin-walled portion and the second-direction thin-walled portion intersect each other in an X shape in the intersecting thin-walled portion when the valve forming surface is seen in a plan view, and
an intersecting angle α between the first-direction thin-walled portion and the second-direction thin-walled portion in the intersecting thin-walled portion is set in a range of 30°≦α≦50°.

3. (canceled)

4. The sealed battery according to claim 1 or 2, wherein
the intersecting thin-walled portion is configured to include a thinner portion than its own other portion.

5. A method of producing a sealed battery comprising:
a power generating element; and
a battery case hermetically housing the power generating element, the battery case including a safety valve part in a valve forming surface,
the safety valve part including:
a plate-like part having a predetermined thickness in its own thickness direction; and
a groove-shaped thin-walled portion formed with a thinner thickness than the plate-like part in the thickness direction and configured to cleave at a time of opening the valve part,
the thin-walled portion including n thin-walled portions (n is an integer more than 2) consisting of first to n-th linear thin-walled portions each linearly extending,
the first to n-th linear thin-walled portions including an intersecting thin-walled portion in which all of the first to n-th thin-walled linear portions intersect each other, and
the thin-walled portion being configured to cleave at a lower cleavage pressure than a cleavage pressure of other portions than the intersecting thin-walled portion,
wherein the method comprises a linear thin-walled portion forming step of forming the first to n-th thin-walled linear portions individually in the plate-like part.

6. The sealed battery according to claim 2, wherein
the intersecting thin-walled portion is configured to include a thinner portion than its own other portion.
